(19) United States
(12) Patent Application Publication
(10) Pub. No.: US 2008/0240877 A1
(43) Pub. Date: Oct. 2, 2008

(54) Cutting device with chip collector

(76) Inventor: Ronald Jude Kirby, Torrance, CA (US)

Correspondence Address: LOUIS L. DACHS, 1794 PALISADES DRIVE, PACIFIC PALISADES, CA, 90272, US

(21) Appl. No.: 11/731,299

(22) Filed: Mar. 30, 2007

(51) Int. Cl. B23B 51/08

(52) U.S. Cl. 408/58

(57) ABSTRACT

The invention is a tool for shaving protruding material off a surface. In detail, the tool includes a housing containing a motor for driving a cutter. A hollow member is mounted to the housing about the cutter, the member having a first end attached to the housing and a second end extending beyond the cutter. The member includes at least one hole there through for allowing shaved off protruding material to pass there through. A vacuum collection system is coupled to the hollow member for collecting shaved protruding material passing through the at least one hole in member.

### GOVERNMENT INTEREST

This invention was made under United States Navy Contract N00019-02-C-3002, issued Oct. 26, 2001. Therefore, the United States Government has rights to the invention as specified in that contract.

### BACKGROUND OF THE INVENTION

1. Field of the Invention

The invention relates to the field of portable cutting devices and the like and, in particular, to a vacuum operated chip collector for collecting chips and the like generated when removing remains of pull rods from fasteners designed for installation from one side of the structures being joined. For example JO Bolt type fasteners.

2. Description of Related Art

There are numerous systems for collecting chips made by drills during drilling operations. For example, U.S. Pat. No. 4,205,728 Suction Attachment For A Drilling Tool, by P. Gloor, et al. which discloses a device which attaches to the surface to be drilled by means of a vacuum attaching device. It also includes a guide hole for a drill, which is coupled to a vacuum line. U.S. Pat. No. 6,413,022 Vacuum Clamp Device by B. Sarb discloses a clamping and attaching device for positioning a drill on structures to be drilled and includes a fixed vacuum operated chip collection device. U.S. Pat. No. 5,346,341 Automatic Chip Removal System For Sign Engraving Machine by G. F. Jambor also discloses a fixed vacuum operated chip collection system for collecting chips from an engraving tool. However, such devices are not usable in situations where protrusions on a surface are to be removed. For example, when installing flush head blind fasteners such as Jo-Bolts, where an internal rod is pulled to expand a member on the blind side, which expands a ring locking the fastener in place. When the fastener is locked in place, the internal rod is designed to break leaving a broken off rough edged protrusion. This protrusion must be subsequently removed.

In the past this protrusion was shaved off by means of a powered tool having a cutter with a retractable stop to prevent the cutter from contacting the surface of the now joined parts or the fastener itself. The retractable stop included holes for allowing the shaved off particles to be expelled from the cutter. However, this allowed the particles to scatter and hit the operator or by-standers or becoming lodged in the surrounding structure.

Thus, it is a primary object of the invention to provide a vacuum operated chip collection system for a cutting device that produces chips and the like.

It is another primary object of the invention to provide a vacuum operated chip collection system for a cutting device that produces chips and the like, which can be used to limit the movement of the cutter.

### SUMMARY OF THE INVENTION

The invention is a tool for shaving protruding material off a surface, such as remaining pull up stems of flush head blind fasteners. In detail, the tool includes housing, having motor for driving a cutter with a cutting end. The motor can be pneumatic or electrically powered. A hollow member is mounted to the housing about the cutter. The member includes a first end attached to the housing and a second end extending beyond the cutting end of the cutter. The member further includes at least one hole there through for allowing shaved off protruding material to pass. A vacuum collection system is mounted to the hollow member for collecting shaved protruding material passing through the at least one hole in the hollow member.

Preferably, the first end of the hollow member is movably mounted to the housing movable from a first position wherein the second thereof is beyond the cutting end to a second position which is a less distance from the cutting end. Preferably, the member is spring biased to the first position. Preferably, the vacuum collection system includes an annular housing having a hollow sleeve adapted to slide over the member. At least one set screw assembly is mounted in the hollow sleeve for securing the annular housing to the member. A flexible line is coupled to the annular housing; and connects the housing to a vacuum pumping system.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a split cross-sectional view of a Jo-Bolt type flush head blind fastener, illustrating the fastener installed and also locked in place.

FIG. 2 is a side view of the tool connected to a system to draw a vacuum.

FIG. 3 is a partial side view of the tool shown in FIG. 1, particularly illustrating the cutter and member and vacuum collection system.

FIG. 4 is a partial cross-sectional view of device in the process of shaving off a protrusion remaining after installation of a fastener.

FIG. 5 is a perspective view of the fastener after the shaving operation.

### DESCRIPTION OF THE PREFERRED EMBODIMENT

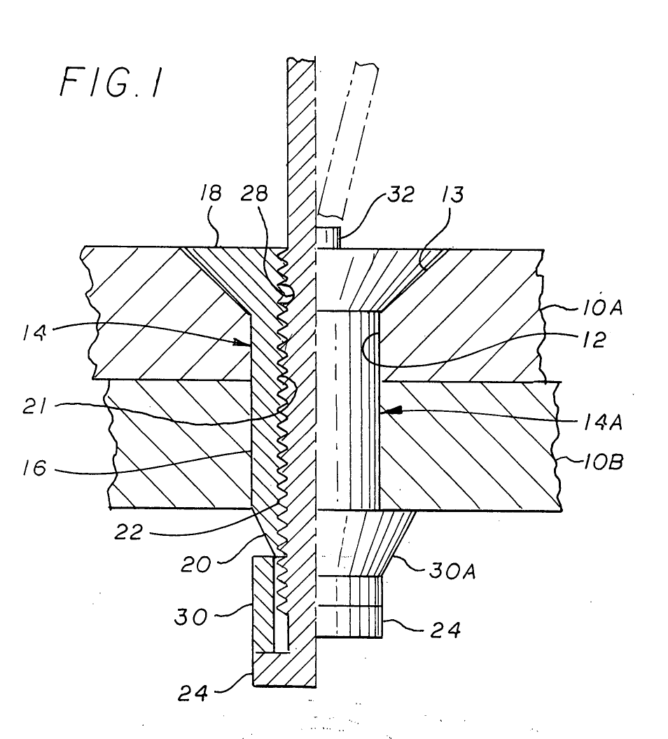

FIG. 1 illustrates a partial view of two sheets 10A and 10B having a fastener hole 12 having a conical countersink portion 13, in which is installed a typical blind flush head fastener, generally indicated by numeral shown before, indicated by numeral 14 and after being locked in place, indicated by numeral 14A. The fastener 14 includes a hollow body portion 16 having a conical shaped head 18 and tapered end 20 and a threaded hole 21 there through. A threaded pin 22 is mounted in the hole 21 having a disc shaped end 24 and a threaded shaft 26 extending out of the end 20.

The pin 22 includes a notched portion 28 designed to break after installation is complete. A deformable sleeve member 30 is mounted between the end 24 of the pin 22 and the tapered end 20 of the body portion 15. A tool (not shown) is used to grip and rotate the pin 22 causing it to move upward such that the end 24 of the pin 22 deforms the sleeve member 30 such that it locks the two sheets 10A and 10B together, indicated by numeral 30A. Continued pulling causes the shaft to break at the notched portion 28 leaving a protrusion 32 extending out of the conical shaped end 18. The subject invention is designed to aid in the removal of the protrusion 32.

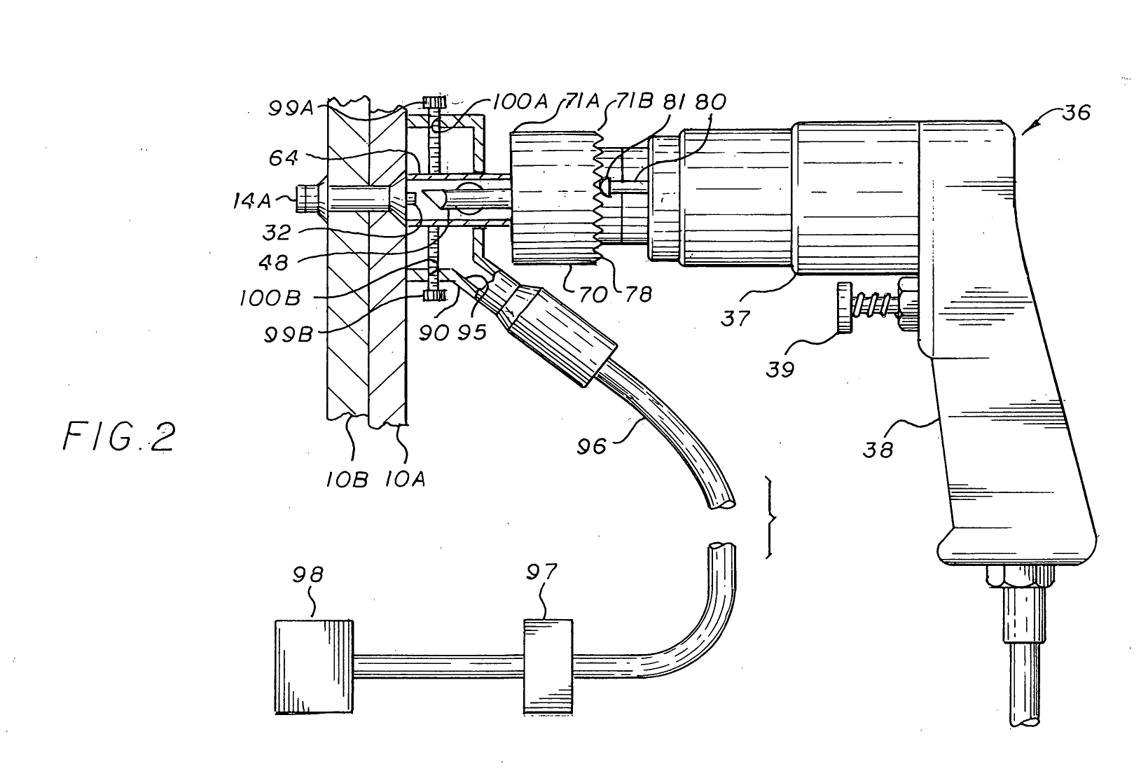

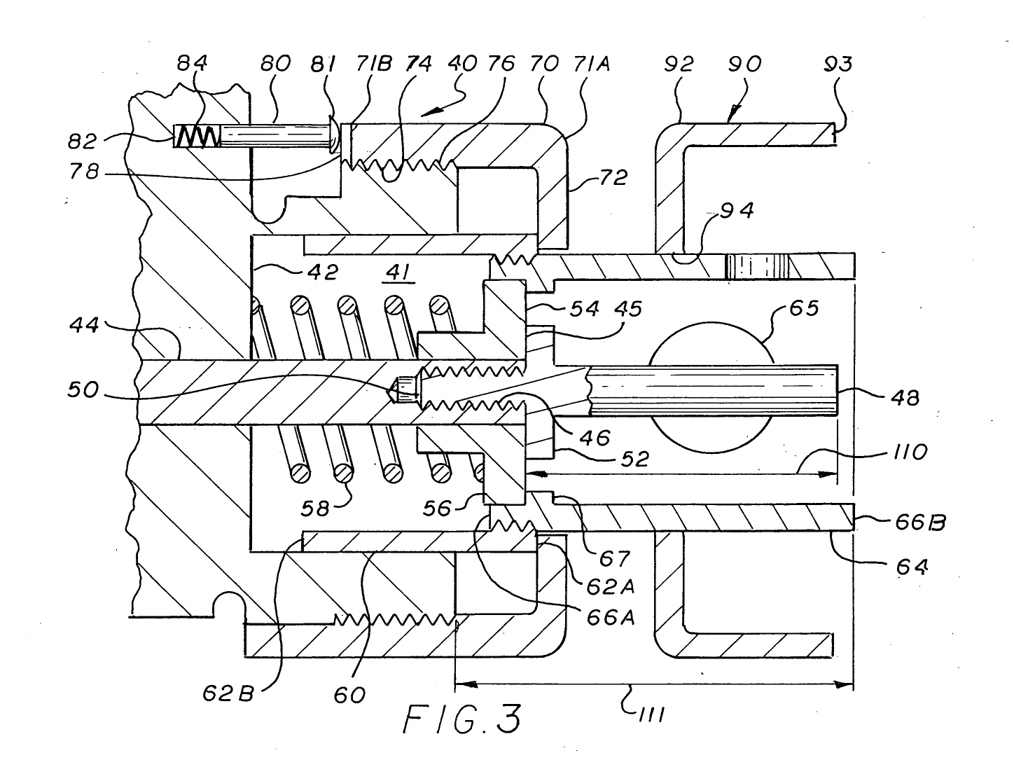

Referring to FIGS. 2 and 3, the device, generally indicated by number 36, is modified commercially available drill; as illustrated, a pneumatically powered drill. However it could be electrically powered. The device 36 includes a body 37, handle 38 and trigger 39. At the body's 37 end 40 is recess 41. A conventional drill mounting shaft 44 extends out of the end 42 of the recess 41 having an end 45 with a threaded hole 46, A cutting tool 48 includes a threaded shaft 50 engaged with the threaded hole 46 and includes a flange 52 seated against the end 45. A bushing 54 having a flange 56 is slidably mounted on the shaft 44. A coil spring 58 is mounted between the flange 56 and extends into the recess 40 and abuts the end 42 thereof. A hollow sleeve 60 is movable mounted in the recess 40 having first and second ends, 62A and 62B. The end 62B includes internal threads 64.

A second sleeve 64 includes a first end 66A having external threads in engagement with the internal threads 64 of the sleeve 60 and a second end 66B extending beyond the cutting tool 48. The sleeve 64 includes at least one hole 65 for allowing chips to pass therethrough. An internal protrusion 67 near the first end 66A abuts the flange 56. A nut 70 includes a first end 71A with an internal flange 72 that abuts the end 62B of the sleeve 60. The nut further includes internal threads 74 that engage external threads 76 on the body 37. Thus rotation of the nut 70 will cause the sleeve 60 to retract until the end 62B of the sleeve abuts the end 42 of the recess 41. This also retracts the second sleeve 64. The second end 71B of the nut includes serrations 78. A pin 80 having a head portion 81 is movably mounted in a hole 82 in the body 37, biased by spring 84 into contact with the serrations 78 of the nut 70 preventing rotation of the nut unless the pin 80 is retracted by hand.

Mounted about sleeve 64 is a chip collection assembly 90, which includes cup shaped housing 92 having a lip 93 and a hole 94 such that it slidably engages the sleeve 64. An outlet port 95 is connected to the interior of the cup 92, which is coupled by a flexible line 96 to a chip collection bag 97 coupled to a vacuum pump 98. The assembly 90 is attached to the sleeve 64 by means of two set screws 99A and 99B that extend through threaded holes 100A and 100B in sleeve cup wall. The assembly 90 is mounted on the sleeve 64 such that the lip 93 of the housing 92 is aligned with the end 66B of the sleeve 64.

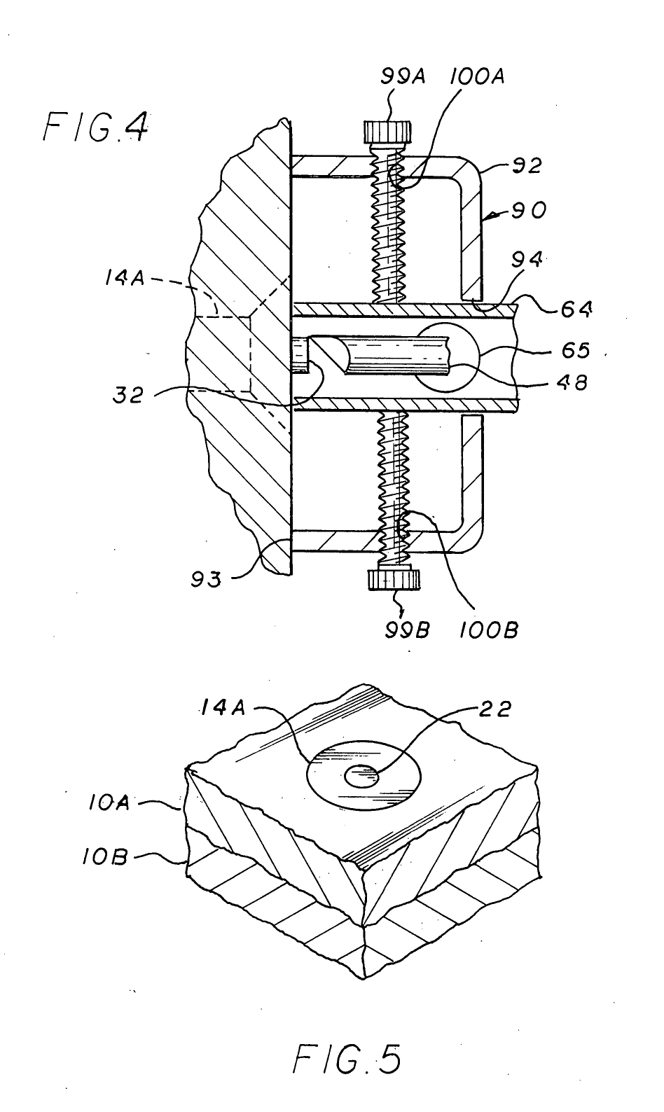

Referring to FIG. 4, with the head 81 of the pin 80 moved out of contact with the serrations 78 of the nut 70, the nut can be rotated to adjust the position of the end 66B of the sleeve 64 in relationship to the end of the drill 48. Thus the extent of the distance of the cutter 48 to the surface of fastener 14 can be adjusted depending upon the length of the protrusion 32. When the device 36 is activated by pulling trigger 39, and the cutter 48 starts to shave of the protrusion, cutter moves closer to the structure, but the sleeve 64 “bottoms out” prior contact with the surface. Thus damage to the surface is prevented. Changes in the length 110 of the cutter can be accommodated by changing the length 111 of the sleeve 64. The shaved off fastener is shown in FIG. 5.

While the invention has been described with reference to a particular embodiment, it should be understood that the embodiment is merely illustrative as there are numerous variations and modifications which may be made by those skilled in the art. Thus, the invention is to be construed as being limited only by the spirit and scope of the appended claims.

### INDUSTRIAL APPLICABILITY

The invention has applicability to any industry using flush head blind head fasteners, such as aircraft manufacturing industries.

1. A tool for shaving protruding material off a surface the tool comprising:
a housing;
a motor mounted in said housing;
a cutter having a cutting end coupled to said motor;
a hollow member mounted to said housing about said cutter, said member having a first end attached to said housing and a second end extending beyond said cutter, said member having at least one hole there through for allowing shaved off protruding material to pass;
a vacuum collection means mounted to said hollow member for collecting shaved protruding material passing through said at least one hole in said hollow member.

2. The cutting device as set forth in claim 1 wherein said first end of said hollow member movably mounted to said housing; said hollow member movable from a first position wherein said second thereof is beyond said cutting end to a second position which is a less distance from said cutting end.

3. The cutting device as set forth in claim 2 wherein said member is spring biased to said first position.

4. The cutting device as set forth in claim 1 or 2, or 3, wherein said vacuum collection means comprises
a cup shaped housing having hollow sleeve adapted to slide over said member:
at least one set screw assembly mounted in said hollow sleeve for securing said sleeve to said member
a flexible line coupled to said annular housing; and
a vacuum pumping system coupled to said flexible line.
